(19) United States
(12) Patent Application Publication
(10) Pub. No.: US 2014/0374679 A1
(43) Pub. Date: Dec. 25, 2014

(54) CABLE INSTALLATION APPARATUS FOR MOUNTING ON A FLANGED STRUCTURE

(71) Applicant: TECHNIP FRANCE, Courbovoie (FR)

(72) Inventor: David MacKay, Highland (GB)

(21) Appl. No.: 14/353,274

(22) PCT Filed: Oct. 23, 2012
(86) PCT No.: PCT/GB2012/052622

§ 371 Date: Apr. 21, 2014

(30) Foreign Application Priority Data
Oct. 31, 2011 (GB) 1118760.6

(51) Int. Cl. H02G 1/08; F03D 1/00; F03D 11/00

(52) U.S. Cl. CPC H02G 1/08; F03D 11/0066; F03D 1/001; F05B 2240/916
USPC 254/134.3 R

(57) ABSTRACT

A cable installation apparatus 2 for mounting on a structure 20 having an internal flange 26 defining an opening at one end, comprising a platform 4; a cable winch 14 mounted on the platform; and a base portion 6 for supporting the platform and attachable to the flange of the structure; wherein the base portion 6 comprises at least one guide member 10 adapted to engage with the flange 26 on which the apparatus is to be mounted to guide the same on to the structure. The apparatus in accordance with the present invention allows the same to be quickly, simply, safely and therefore inexpensively installed on a flanged end of a structure, such as a turbine tower section, in a single lifting and alignment operation.

The present invention relates to an apparatus for installing cables in a structure comprising a flange or other suitable landing interface, such as a wind turbine tower section or foundation. The invention more specifically relates to a cable pull-in apparatus for mounting on a wind turbine tower section or foundation.

A known method of installing cables in a wind turbine tower section or foundation involves a pull-in winch which is first landed, with other required equipment, onto a service platform mounted directly on a flanged upper end of the installed tower section. The winch is used to pull the cable up through the tower section before a generator is installed thereon and the cables can be connected thereto. The cables may be pulled through al-tube' which is often provided at the foundation of such a tower and which comprises a so called ‘bell mouth’ to guide the cables into the tube. A number of guide sheaves may also be provided by rigging inside the tower wall to guide the cable up through the same.

However, such a known method of cable pull-in requires a number of separate lifting operations to first install the service platform and then install the pull-in winch and other equipment. Such lifting operations are conducted by a crane mounted on a barge or vessel positioned in the vicinity of the tower section resulting in known methods of cable pull-in being particularly time consuming and costly. This is made more undesirable in adverse weather conditions due to the heightened inherent risks involved for equipment and personnel when undertaking multiple lifting operations.

A first aspect of the present invention provides a cable installation apparatus for mounting on a structure having an internal flange defining an opening at one end, comprising:

a platform;

a cable winch mounted on the platform; and

a base portion for supporting the platform and attachable to the flange of the structure;

wherein the base portion comprises at least one guide member adapted to engage with the flange on which the apparatus is to be mounted to guide the same on to the structure.

The invention allows a vessel crane to quickly and simply lift, maneuver and position the apparatus onto a flanged end of a structure, such as a wind turbine tower section, in a single lifting operation. The winch may be suitably mounted to the platform before lifting or may be permanently mounted to the platform and is preferably a ‘pull-in’ winch for pulling array cables up, and other rigging such as messenger wires, from the tower base to the upper flanged end to allow for connection to a generator when later installed. The at least guide member aids an operator to align the base of the apparatus with the flange of the tower section and eliminates the need for personnel to be present in the tower during lifting and positioning which can otherwise be particularly hazardous.

Preferably the base is removeably attached to the platform. This allows the base to be interchangeable with the platform. Suitably a base may be selected from a plurality of differently sized bases to correspond with a particular structure size, such as the diameter of a tower section flange. This allows a single platform to be used with a range of differently sized bases to suit structures of differing size. Detachment of the base from the platform also allows for easy and compact stowage of the apparatus when not in use, for example when being stored onshore or transported to or from an offshore site. Suitably the base and/or platform are adapted to be stacked for compact stowage, such as when sea fastened to the deck of a vessel.

Preferably the base is adapted to axially position the platform over the flanged opening of the structure. Preferably the winch is mounted on the platform to provide for axial routing of the pull-in winch wire and cables being installed up through the structure. This allows for balanced winching of the winch wire and cable(s) and eliminates the need for lifting points on the inside of the structure.

Suitably the base may comprise a platform attachment portion for attaching to the platform and the at least one guide member extends therefrom. Suitably the attachment portion may correspond in size and shape with the platform. For example, the platform and attachment portion may be substantially square to correspondingly engage with and attach to each other. Alternatively, the platform and attachment portion may be substantially circular in shape.

Suitably the at least one guide member may comprise an annular portion which extends downwardly from the attachment portion when in use and which has a diameter corresponding to that of the flanged opening to allow it to be received thereby. Once safely inserted into the flanged opening of the structure, the base of the apparatus may be securely attached to the structure by, for example, bolting directly to the flange. Suitably the guide member may comprise an angled engagement surface for engagement with the flanged opening of the structure to further aid alignment and insertion therewith. The base may also include a “soft landing” mechanism to enable the unit to be deployed in more severe sea states.

Preferably the base comprises at least three spaced elongate members downwardly extending from the platform attachment portion. Alternatively, each elongate member may be adapted to attach directly to the platform. Preferably each elongate member extends downwardly and outwardly from the platform attachment portion to provide a tripod-like base for supporting the platform. Preferably the elongate members are equally spaced relative to an axis of the apparatus to define a 120 degree spacing between each free end of the elongate members. Suitably the elongate members may be fixed to the platform attachment portion or they may be moveable relative to the platform attachment portion to allow for easy stowage when not in use. For example, the elongate members may each be pivotally attached to the platform attachment portion to allow them to fold inwardly when the apparatus is not in use. When in use, the elongate members may be moved outwardly into an open position for engagement with the flanged opening of a structure. Suitably the apparatus may comprise an actuator to deploy the guide members into the open position and retract the same into a closed position when not in use. Suitably the actuator may be electrically, pneumatically or hydraulically operated.

Such a pivotal attachment of each elongate member to the platform attachment portion suitably allows the same to move relative to the platform attachment portion to accommodate for different sizes of flanged opening of a structure. For example, for a flange diameter of 5 metres, each elongate member would be orientated at an angle a relative to the horizontal to provide a height H1 between the platform attachment portion and the flange of the structure. For a flange diameter of 7 metres, each elongate member would be moved outwardly to define an angle 13 relative to the horizontal, where 13 is greater than a. However, the height H2 between the platform attachment portion and the 7 metre flange would be less than H1. If it was desirable for H1 and H2, for example, to be the same, each elongate member may be adjustable in length to accommodate different sizes of flange. Suitably each elongate member may be telescopic and may selectively adjustable by suitable means.

Alternatively, each elongate member may comprise a first part fixedly attached to the platform attachment portion and a second part hingedly attached to the first part at a distal end relative to the platform attachment portion. Preferably the second part is arranged to move relative to the first part about a horizontal axis. In use, the first part will be an upper part and the second part will be a lower part. The second part may be selectively moveable relative to the first by suitable means, such as a motor. Such selective movement between the first and second parts of each elongate member allows the same to adjust accordingly to accommodate different sizes of flange. Where the flange is 5 metres in diameter, for example, the first and second parts of each elongate member may be longitudinally aligned to define an angle a of 180 degrees between the first and second parts and a height H1 between the platform attachment portion and the flange. Where the flange is 7 metres, for example, the second part of each elongate member is suitably moved relative to the first part to define an angle a of less than 180 degrees to accommodate for the increased diameter of the flange. Of course, if a length L2 of the second part of the elongate member remains unchanged, a height H2 between the platform attachment portion will be less than H1 for the 5 m diameter flange. Alternatively, the length L2 of the second part may be selectively adjustable to accommodate for different flange sizes thereby to ensure the first and second parts remain longitudinally aligned and/or the height of the platform attachment portion remains the same irrespective of the size of flange the same is mounted to. For example, where the flange is 7 metres in diameter, the length of the second part may be increased to longitudinally align the first and second parts to define an angle a therebetween of 180 degrees and to provide a height H3 between the platform attachment portion and the flange. In this case, H3 would be greater than H1 for the 5 metre flange which would provide increased space between the platform and flange for handling cabling and cable bights, for example, during installation. In this case, the second part may comprise at least two portions which are telescopically coupled together, for example.

Preferably each free end of the elongate members comprises a flange attachment portion. Where the elongate member comprises first and second parts, the second part would comprise the free end. Suitably each flange attachment portion may comprise one or more holes corresponding to bolt holes in the flange of the structure for securely attaching the apparatus thereto. Suitably each flange attachment portion may comprise a plate for engagement with an upper surface of the flange which comprises the bolt holes.

Preferably each free end comprises a guide member. Each guide member may be suitably attached to its corresponding elongate member or may be integral therewith. Each guide member may be welded to its corresponding elongate member, for example. Preferably each guide member is provided internally of its corresponding flange attachment portion relative to the axis of the structure for suitable engagement with the flanged opening. Preferably each guide member downwardly extends from its corresponding elongate member and beyond its corresponding flange attachment portion. Preferably each guide member comprises an angled outer surface for engagement with the flanged opening when in use to aid alignment therewith. Suitably each guide member may be plate-like. The angled surface of each guide member may be provided by an edge of the plate or may be provided by a skid attached to an edge of each guide member. Suitably each skid may be perpendicular to a vertical plane of its corresponding guide member.

Suitably the platform may comprise an access ladder, safety railings and/or grating. Preferably the apparatus comprises at least one attachment point to allow a vessel crane to securely attach to lift and maneuver the apparatus into position on a structure. Such an attachment point may comprise a loop, eye or shackle, for example.

Suitably the apparatus may comprise additional equipment for cable pull-in such as rigging, lighting, power generation for the winch and/or lighting and safety equipment, for example. Other equipment may include de-gassing apparatus to support manned entry into confined spaces within the structure, such as the foundation of a structure. As personnel may remain on the structure/platform for extended periods of time during normal operation conditions, or longer in emergency conditions caused, for example, by adverse weather conditions, the apparatus may further comprise survival and welfare equipment such as sleeping bags, chemical toilet and emergency rations, for example. The apparatus may suitably comprise storage facilities for such equipment. In addition, as the apparatus may typically be installed on a structure for a significant period of time, it may comprise suitable protection covers to protect the apparatus itself, particularly in an offshore environment, and also to protect the inside of the structure on which it is mounted from the elements. Should the flange feature a pre-installed protection cap, the apparatus may be adapted to interface with the cap, eliminating the requirement to recover the cap prior to deployment of the pull in module.

A further aspect of the present invention provides an apparatus as described above mounted on a structure having an internal flange defining an opening at one end. Preferably the structure is a wind turbine tower section or foundation.

A further aspect of the present invention provides a method of installing a cable in a structure having an internal flange defining an opening at one end, comprising the steps of:

providing an apparatus as described above;

attaching lifting equipment thereto;

lifting the apparatus and positioning the same over the flanged opening of the structure;

lowering the apparatus towards the flanged opening to engage the at least one guide member therewith;

aligning the apparatus with the flanged opening;

attaching the apparatus to the flange;

removing the lifting equipment;

lowering a winch wire of the winch to offer the same up to a cable to be installed;

attaching the winch wire to the cable;

operating the winch to pull the cable up through the structure; and

removing the winch wire from the cable to complete said installation.

The method may further comprise one or more of the following steps:

deploying one or more guide members into an open position; and

recovering the apparatus from the structure using the lifting equipment.

The method may further comprise one or more of the following steps:

providing one or more guide members each comprising first and second parts; and

selectively moving a first part relative to the second part to accommodate a particular flange size and/or to define a desired height between the platform attachment portion and the flange and/or to define a desired angle between the first and second parts.

Suitably such movement between the first and second parts of each guide member may be pivotal and/or axial movement therebetween. Suitably the first and second parts may be telescopically arranged to provide for such axial movement.

Alternatively or additionally, the second part may comprise at least two portions arranged to move axially relative to each other, such as a telescopic arrangement. Suitably the lifting equipment may be a vessel crane.

An embodiment of the present invention will now be described by way of example only with reference to the accompanying drawings in which:

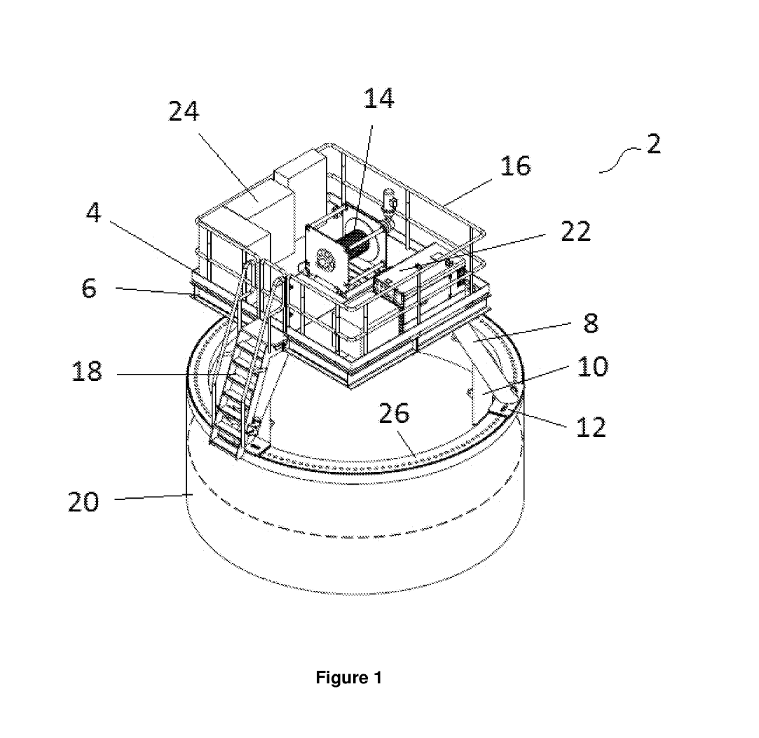

FIG. 1 shows a cable installation apparatus mounted on a flanged end of a turbine tower section;

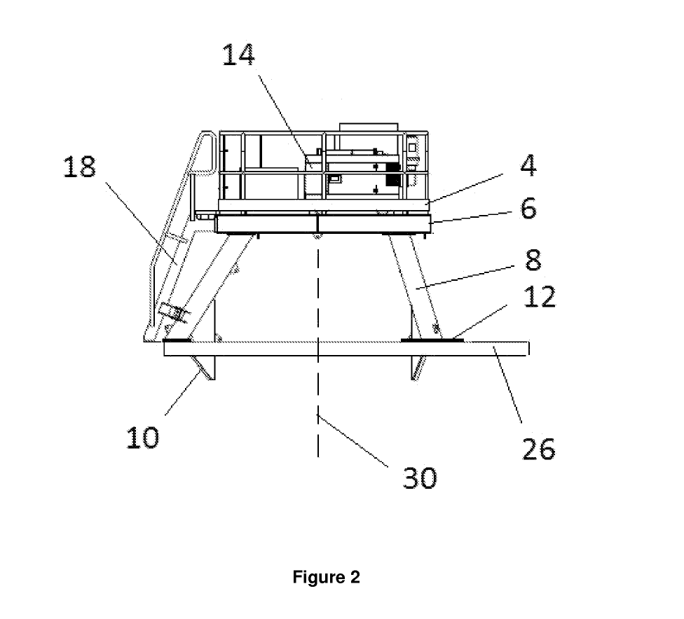

FIG. 2 shows a side view of the apparatus of FIG. 1;

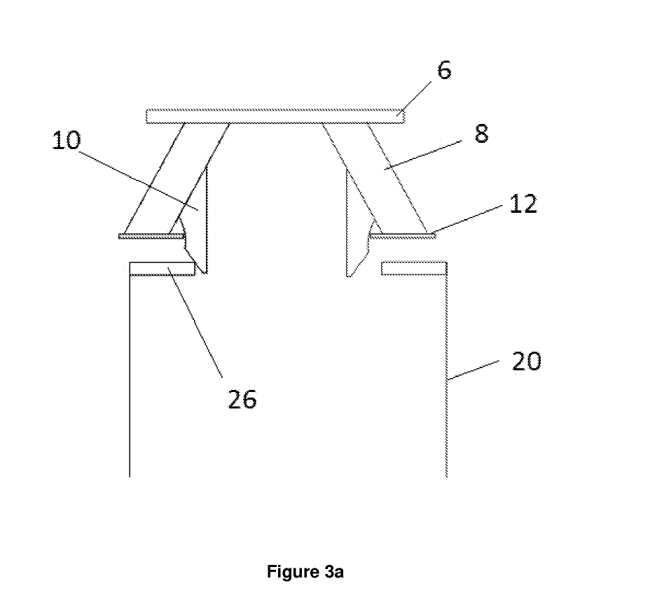

FIG. 3a shows the apparatus being lowered into and aligned with the flanged opening of a tower section;

FIG. 3b shows the apparatus of FIG. 2a in position;

FIG. 3c shows a close up view of the apparatus engaged with the flange of a tower section;

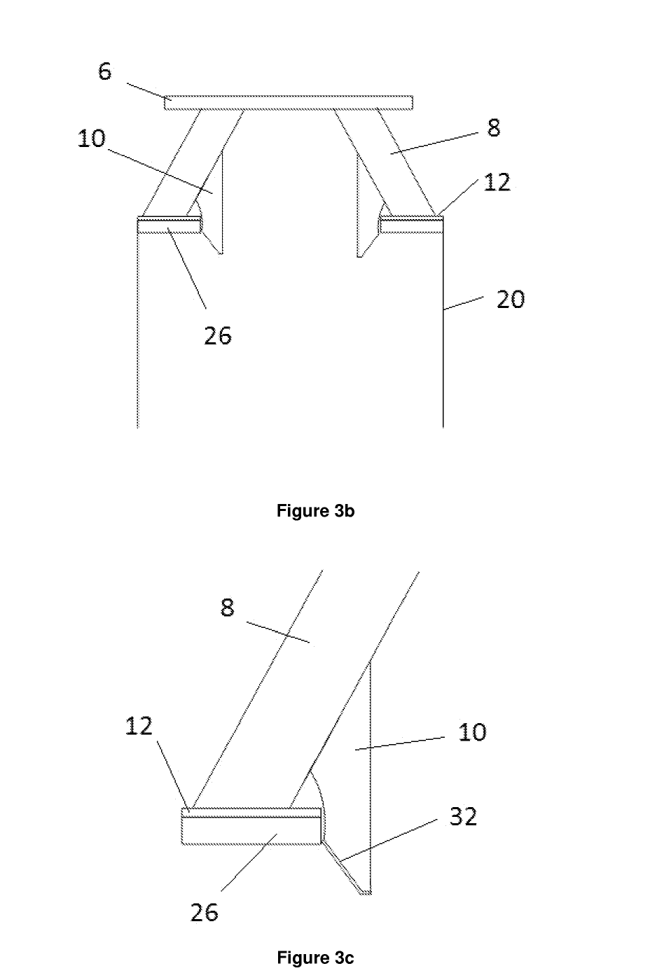

FIGS. 4a and 4b show a further embodiment of the invention to accommodate for different flange sizes; and

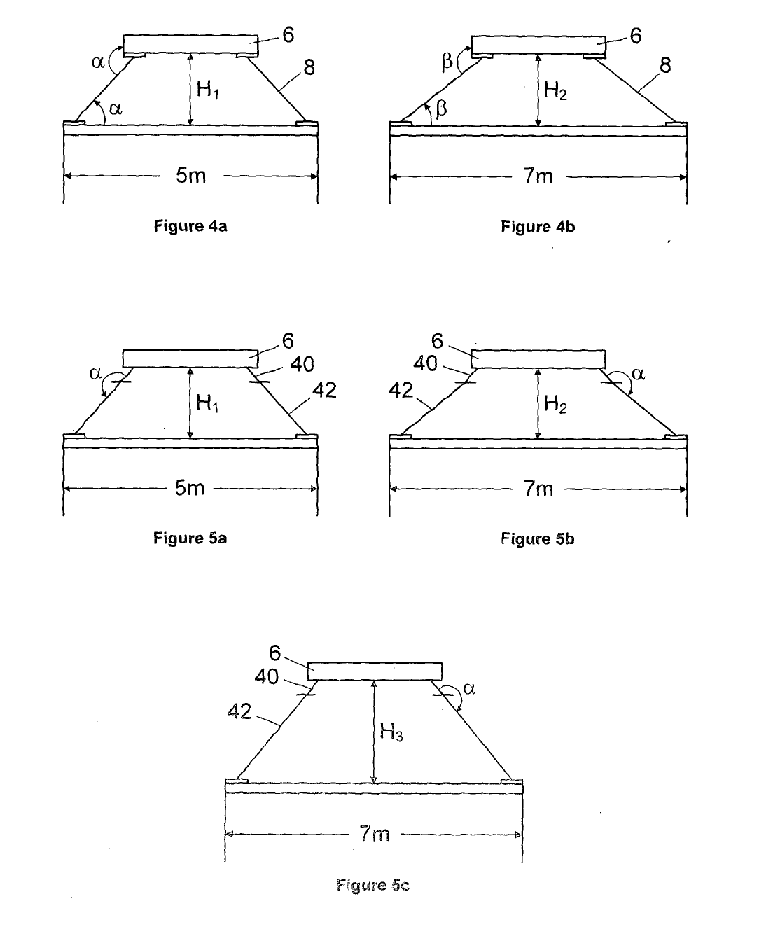

FIGS. 5a to 5c show a further embodiment of the invention to accommodate for different flange sizes.

As shown in FIGS. 1 and 2, a cable installation apparatus 2 comprises a square platform 4 for mounting a cable winch 14, generator 22 and storage units 24 all surrounded by safety railings 16. Access steps 18 lead up to a gate in the railings for accessing the platform. The winch 14 is mounted centrally on the platform and an opening (not shown) in the platform floor or grating allows the winch to lower or raise a winch wire below the platform.

The platform 4 is supported by a base 6, 8 which includes a platform attachment portion 6 being complimentarily shaped with the platform and three legs 8 extending downwardly and outwardly from the platform attachment portion 6. Each leg 8 has a flange attachment portion 12 at a free end distal from the platform attachment portion 6 which include holes for flange bolts to pass through to attach the apparatus to a flange 26 of a turbine tower section 20. The legs 8 are attached to the platform attachment portion 6 to provide a spacing of 120 degrees between each flange attachment portion 12. This desirably centralises the apparatus on the tower section relative to axis 30 thereof and ensures the winch operates axially making cable installation simpler, quicker and safer. This also ensures the centre of gravity of the apparatus is central relative to the tower axis 30. The weight of the apparatus is spread equally on the flange whilst also providing for balanced support of the platform, particularly during cable pull-in when the winch is operating. Each leg 8 further includes a guide member 10 extending downwardly from its corresponding leg 8. In use, the inner edge of each guide member 10 relative to axis 30 acts as an engagement surface to engage with the flange opening when the apparatus is being lowered onto the tower section. The guide members 10 guide the apparatus into alignment with the flange when being lowered onto the tower section. The engagement surface of each guide member 10 is angled to aid the alignment.

FIGS. 3a to 3c show the apparatus being installed on a tower section, with the platform not shown for simplicity. The apparatus would typically be deployed prior to cable installation. In order to deploy the apparatus, a team of personnel (known in the industry as a “tower team”) would first access the tower section 20. The tower team would ensure the tower section is safe, clean and that the flange is ready to accept the apparatus. The apparatus deployment vessel would then position within crane reach of the tower section in preparation to transfer the apparatus. A team onboard the vessel would then attach the vessel crane to the apparatus. The vessel crane is then used to transfer the apparatus onto the tower section 20.

FIG. 3a shows the apparatus being lowered by a vessel crane towards the tower section 20 to engage with the flange 26. The angled engagement surface of guide member 10 helps to guide and align the apparatus into position on the flange 26. Once in position, as shown in FIG. 3b, the flange attachment portions 12 are bolted to the flange with flange bolts (not shown) and the vessel crane is removed from the apparatus. FIG. 3c shows the flange/apparatus interface. The engagement surface of each guide member 10 may be provided by a skid 32 which is attached perpendicularly to its corresponding guide member 10.

As shown in FIGS. 4a and 4b, each leg 8 may be pivotally attached to the platform attachment portion 6 to accommodate for different sizes of flanged opening of a structure on which it is to be mounted. For example, for a flange diameter of 5 metres, each leg 8 would be orientated at an angle a relative to the horizontal to provide a height H1 between the platform attachment portion and the flange of the structure. For a flange diameter of 7 metres, each leg 8 would be moved outwardly to define an angle 13 relative to the horizontal, where 13 is greater than a. However, the height H2 between the platform attachment portion 6 and the 7 metre flange would be less than H1. If it was desirable for H1 and H2, for example, to be the same, each leg 8 may be adjustable in length to accommodate different sizes of flange. Suitably each leg 8 may be telescopic and may selectively adjustable by suitable means.

Alternatively, as shown in FIGS. 5a to 5c, each leg 8 may comprise a first part 40 fixedly attached to the platform attachment portion 6 and a second part 42 hingedly attached to the first part 40 at a distal end relative to the platform attachment portion 6. The second part 42 is arranged to move relative to the first part 40 about a horizontal axis. The first part 40 is an upper part and the second part 42 is a lower part. The second part 42 may be selectively moveable relative to the first part 40 by suitable means, such as a motor. Such selective movement between the first and second parts of each leg 8 allows the same to adjust accordingly to accommodate different sizes of flange. Where the flange is 5 metres in diameter, for example, the first and second parts of each leg 8 may be longitudinally aligned to define an angle a of 180 degrees between the first and second parts and a height H1 between the platform attachment portion 6 and the flange. Where the flange is 7 metres, for example, the second part 42 of each leg 8 is suitably moved relative to the first part 40 to define an angle a of less than 180 degrees to accommodate for the increased diameter of the flange. Of course, if a length L2 of the second part 42 of the leg 8 remains unchanged, a height H2 between the platform attachment portion 6 will be less than H1 for the 5 m diameter flange. Alternatively, the length L2 of the second part 42 may be selectively adjustable to accommodate for different flange sizes thereby to ensure the first and second parts remain longitudinally aligned and/or the height of the platform attachment portion 6 remains the same irrespective of the size of flange the same is mounted to. For example, where the flange is 7 metres in diameter, the length of the second part 42 may be increased to longitudinally align the first and second parts to define an angle a therebetween of 180 degrees and to provide a height H3 between the platform attachment portion 6 and the flange. In this case, H3 would be greater than H1 for the 5 metre flange which would provide increased space between the platform and flange for handling cabling and cable bights, for example, during installation. In this case, the second part 42 may comprise at least two portions which are telescopically coupled together, for example.

The tower team is responsible for landing the apparatus on the tower section 20 and disconnecting the lift rigging when the apparatus is securely attached to the tower section 20. The apparatus is then set up in preparation for its operation. The next task undertaken by the tower team is the installation of messenger wires. The apparatus may be used to aid this task as gas-freeing equipment may be used to facilitate manned entry into the cable basement of the tower. The cable winch 14 may also be deployed to assist in messenger wire recovery. At this stage the apparatus would be shut down and made secure. The tower team would depart from the tower section to prepare other monopoles for cable pull in.

Prior to cable pull in, a tower team would access the foundation and set up the apparatus. The cable winch wire would then be recovered to the cable lay vessel and the cable is recovered. Following cable pull-in, the apparatus is closed down and recovered to the vessel in the same manner as it was deployed. The tower team finally make the tower secure in preparation for the tower and turbine installation and connection of the cables therewith.

The apparatus in accordance with the present invention allows the same to be quickly, simply, safely and therefore inexpensively installed on a flanged end of a structure such as a turbine tower section in a single lifting and alignment operation.

What is claimed is:

1. A cable installation apparatus for mounting on a structure having an internal flange defining an opening at one end, comprising:
a platform;
a cable winch mounted on the platform; and
a base portion for supporting the platform and attachable to the flange of the structure;
wherein the base portion comprises at least one guide member adapted to engage with the flange on which the apparatus is to be mounted to guide the same on to the structure.

2. An apparatus according to claim 1 wherein the base is removeably attached to the platform.

3. An apparatus according to claim 2 wherein the base is selected from a plurality of differently sized bases to correspond with a particular structure size.

4. An apparatus according to claim 2 wherein the base and/or platform are adapted to be stacked for compact stowage.

5. An apparatus according to claim 1 wherein the base is adapted to axially position the platform over the flanged opening of the structure.

6. An apparatus according to claim 5 wherein the winch is mounted on the platform to provide for axial routing of the pull-in winch wire and cables being installed up through the structure.

7. An apparatus according to any preceding claim 1 wherein the base comprises a platform attachment portion for attaching to the platform and the at least one guide member extends therefrom.

8. An apparatus according to claim 7 wherein the attachment portion corresponds in size and shape with the platform.

9. An apparatus according to claim 7 wherein the base comprises at least three spaced elongate members downwardly extending from the platform attachment portion.

10. An apparatus according to claim 9 wherein each elongate member extends downwardly and outwardly from the platform attachment portion to provide a tripod-like base for supporting the platform.

11. An apparatus according to claim 9 wherein the elongate members are equally spaced relative to an axis of the apparatus to define a 120 degree spacing between each free end of the elongate members.

12. An apparatus according to claim 9 wherein each elongate member comprises a first part fixed to the platform attachment portion and a second part moveably connected to the first part.

13. An apparatus according to claim 12 wherein the second part is hingedly attached to the first part to move about a horizontal axis.

14. An apparatus according to claim 12 wherein the second part is adapted to move axially relative to the first part.

15. An apparatus according to claim 12 wherein a length of the second part is adjustable.

16. An apparatus according to claim 15 wherein the second part comprises at least two portions telescopically coupled together.

17. An apparatus according to claim 9 wherein each free end of the elongate members comprises a flange attachment portion.

18. An apparatus according to claim 17 wherein each flange attachment portion comprises one or more holes corresponding to bolt holes in the flange of the structure for securely attaching the apparatus thereto.

19. An apparatus according to claim 9 wherein each elongate member comprises a guide member at a free end.

20. An apparatus according to claim 19 wherein each guide member is provided internally of its corresponding flange attachment portion relative to the axis of the structure for suitable engagement with the flanged opening.

21. An apparatus according to claim 20 wherein each guide member downwardly extends from its corresponding elongate member and beyond its corresponding flange attachment portion.

22. An apparatus according to claim 19 wherein each guide member comprises an angled outer surface for engagement with the flanged opening when in use to aid alignment therewith.

23. An apparatus according to claim 1 wherein the platform comprises an access ladder, safety railings and/or grating.

24. An apparatus according to any preceding claim 1 further co rises comprising at least one attachment point to allow a vessel crane to securely attach to lift and maneuver the apparatus into position on a structure.

25. An apparatus according to any preceding claim 1 further comprising one or more of rigging, lighting, power generation, safety equipment, de-gassing apparatus, survival and welfare equipment, storage facilities, shelter for personnel, and a protection cover for the apparatus and/or structure.

26. An apparatus according to any preceding claim 1 mounted on a structure having an internal flange defining an opening at one end.

27. An apparatus according to claim 26 wherein the structure is a wind turbine tower section or foundation.

28. (canceled)

29. A method of installing a cable in a structure having an internal flange defining an opening at one end, comprising the steps of:
providing an apparatus in accordance with claim 1;
attaching lifting equipment thereto;
lifting the apparatus and positioning the same over the flanged opening of the structure;
lowering the apparatus towards the flanged opening to engage the at least one guide member therewith;
aligning the apparatus with the flanged opening;
attaching the apparatus to the flange;
removing the lifting equipment;
lowering a winch wire of the winch to offer the same up to a cable to be installed;
attaching the winch wire to the cable;
operating the winch to pull the cable up through the structure; and
removing the winch wire from the cable to complete said installation.

30. A method according to claim 29 further comprising one or more of the following steps:
deploying one or more guide members into an open position; and
recovering the apparatus from the structure using the lifting equipment.

31. A method according to claim 29 further comprising one or more of the following steps:
providing one or more guide members each comprising first and second parts; and
selectively moving a first part relative to the second part to accommodate a particular flange size and/or to define a desired height between the platform attachment portion and the flange and/or to define a desired angle between the first and second parts.
